(19) United States
(12) Patent Application Publication
(10) Pub. No.: US 2026/0273743 A1
(43) Pub. Date: Sep. 17, 2026

(54) CONTROLLING STABILITY OF MOBILE MANIPULATORS BY SELECTING OF ONE OR MORE STABILIZATION ADJUSTMENT METHODS

(71) Applicant: ABB Schweiz AG, Baden (CH)

(72) Inventors: Arne-Christoph Hildebrandt, München (DE); Jonas Larsson, Västerås (SE); Christoph Bick, Augsburg (DE)

(73) Assignee: ABB Schweiz AG, Baden (CH)

(21) Appl. No.: 19/669,646

(22) Filed: May 6, 2026

Related U.S. Application Data
(63) Continuation of application No. PCT/EP2023/081087, filed on Nov. 8, 2023.

(51) Int. Cl. B25J 9/16; B25J 19/00

(52) U.S. Cl. CPC B25J 9/1664; B25J 9/162; B25J 19/002

(57) ABSTRACT

A method for controlling a mobile manipulator comprising a manipulator base and a manipulator arm includes determining a current configuration, determining a desired movement trajectory of the mobile manipulator, determining current zero-movement points (ZMP) trajectory, comprising the location of one or more current ZMP of the mobile manipulator, based on the current configuration and the desired movement trajectory, determining a desired ZMP trajectory, adjusting the mobile manipulator such that the current ZMP trajectory corresponds to the desired ZMP trajectory by selecting a stabilization method out of a group of stabilization methods and adjusting the mobile manipulator based on the selected stabilization method, determining if the real ZMP trajectory of the mobile manipulator corresponds to the desired ZMP trajectory, and when the real ZMP trajectory of the mobile manipulator corresponds to the desired ZMP trajectory, executing a movement trajectory of the mobile manipulator.

### CROSS-REFERENCE TO RELATED APPLICATIONS

The instant application claims priority to International Patent Application No. PCT/EP2023/081087, filed Nov. 8, 2023, which is incorporated herein in its entirety by reference.

### FIELD OF THE DISCLOSURE

The present disclosure generally relates to a method for controlling a mobile manipulator, a mobile manipulator, a computer program product, and a computer-readable medium.

### BACKGROUND OF THE INVENTION

In recent years, automation industry is focusing more and more on automating applications in industries with limited space. These applications often consist of combinations of transportation tasks in laboratory environments and pick & place tasks on different workplaces. A robot type, which is proposed to answer these needs, is the mobile manipulator. It combines a mobile base with an attached manipulator. Due to limited space in laboratory environments, the requirements on the size of these robots are increasing. Especially the footprint size of the robot is in the focus for optimization. Common manipulators often comprise a heavy and large base, which may be disadvantageous when the robots should operate in constrained spaces. In addition to the size of the robot, the overall time the robot needs to execute tasks has to be constantly decreased. This need leads to higher acceleration of the mobile base while navigating and while executing pick and place tasks. A challenge that arises from these requirements is to ensure that the robot stays stable and, for instance, does not tip over. Problems at the stability may occur with higher dynamic forces which therefore increases the challenge to ensure the stability of the robot.

Thus, there is a need for sophisticated approaches to prevent an instability of a mobile manipulator.

### BRIEF SUMMARY OF THE INVENTION

The present disclosure generally relates to a method for controlling a mobile manipulator comprising a manipulator base and at least one manipulator arm.

The method comprises the steps of: determining a current configuration of the mobile manipulator including a manipulator arm configuration and a manipulator base configuration; determining a desired movement trajectory of the mobile manipulator; determining a current zero-movement points, ZMP, trajectory, comprising the location of one or more current ZMP of the mobile manipulator, based on the current configuration of the mobile manipulator and the desired movement trajectory; determining a desired ZMP trajectory of the mobile manipulator, wherein each ZMP is located within a support polygon of the manipulator base; adjusting the mobile manipulator such that the current ZMP trajectory corresponds to the desired ZMP trajectory.

In the method according to the present disclosure, the step of adjusting the mobile manipulator comprises the step of selecting a stabilization method out of a group of stabilization methods and adjusting the mobile manipulator based on the selected stabilization method. Further, the step of adjusting the mobile manipulator comprises the step of determining if the real ZMP trajectory of the mobile manipulator corresponds to the desired ZMP trajectory. Further, when the real ZMP trajectory of the mobile manipulator corresponds to the desired ZMP trajectory, the method further comprises the step of executing a movement trajectory of the mobile manipulator.

Accordingly, a flexible method for stabilizing mobile manipulators using a selected one out of a group of stabilization methods, which may ensure that the mobile manipulator stays stable and does not tip over, may be provided.

### BRIEF DESCRIPTION OF THE SEVERAL VIEWS OF THE DRAWING(S)

For a better understanding of the present invention, and to illustrate its practicality, figures are provided in the following and reference is made thereto. It should be understood that the figures represent only exemplary embodiments and thus in no way limit the scope of the claimed invention. Identical or like-acting elements are indicated throughout by the same reference signs. Any reference signs in the claims should not be construed as limiting the scope of the claims.

In the accompanying drawings,

FIGS. 1A and 1B schematically illustrates a mobile manipulator according one embodiment of the present invention in different configurations;

FIG. 2 is a flowchart illustrating a method for controlling a mobile manipulator according to the present invention;

FIG. 3 is a flowchart illustrating a method for controlling a mobile manipulator according to the present invention;

FIG. 4 is a flowchart illustrating a method for controlling a mobile manipulator according to the present invention;

FIG. 5 is a flowchart illustrating a method for controlling a mobile manipulator according to the present invention;

FIG. 6 is a flowchart illustrating a method for controlling a mobile manipulator according to the present invention;

FIG. 7 is a flowchart illustrating a method for controlling a mobile manipulator according to the present invention;

FIG. 8 is a flowchart illustrating a method for controlling a mobile manipulator according to the present invention;

FIG. 9 is a flowchart illustrating a method for controlling a mobile manipulator according to the present invention;

FIG. 10 schematically illustrates a mobile manipulator according to one embodiment of the present invention; and

FIGS. 11A and 11B schematically illustrates a mobile manipulator according to one embodiment of the present invention in different configurations.

### DETAILED DESCRIPTION OF THE INVENTION

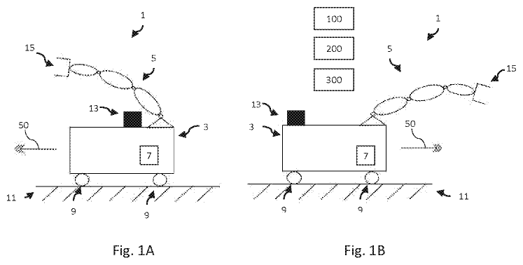

FIGS. 1A and 1B depict a mobile manipulator 1 according to the present invention. The mobile manipulator 1 comprises a manipulator base 3 and a manipulator arm 5 attached at the top side of mobile base 3. It will be understood that in different embodiments, also more than one manipulator arm 5 may be provided and that the position of the one or more manipulator arms 5 may vary, e.g. the manipulator arm 5 may be provided at the front or back side or at a lateral side of the of the mobile manipulator 1. The mobile manipulator arm 5 is formed as a movable arm comprising multiple arm elements which are linked together to allow a flexible movement and extension or retraction of the arm. However, it will be understood that in different environments also a stiff manipulator arm may be provided consisting for instance only of a single stiff arm element movably attached to the manipulator base 3. The manipulator arm 5 is hinged at a proximal end of the manipulator arm 5 with the mobile phase 3 and comprises a tool center point, TCP, 15 at the distal end of the manipulator arm. In the depicted embodiment, the TCP 15 is formed as a gripper to allow a grip of an external item or load. The manipulator base 3 comprises contact elements 9 in form of wheels to contact the floor 11. Thus, the mobile manipulator 1 may be moved along the floor 11. During movement of the mobile manipulator 1, the manipulator arm 5 is essentially in a fixed condition. However, along the movement trajectory, different fixed arm positions may be provided. For instance, when the mobile manipulator 1 moves along a certain movement trajectory comprising multiple tracks, a distinct arm position may be assumed, as shown in FIG. 1A, at a first movement path section. A different distinct arm position, as shown in FIG. 1B, may be accordingly provided at a second first movement path section. In FIG. 1A the mobile manipulator 1 moves towards the left side, as depicted by arrow 50. In FIG. 1B the mobile manipulator one moves towards the right side, as depicted by arrow 50. The mobile manipulator 1 may be moved along a predefined movement trajectory.

The mobile manipulator 1 further comprises a mass element 13, arranged at the top surface of the manipulator base 3. However, in different embodiments of the present invention, no additional mass elements are provided. As shown, the mass element 13 can be located at different positions with respect to the manipulator base 3. For instance, as shown in FIG. 1A, the mass element 13 is arranged at the right side of the manipulator base 3, close to the proximal side of the manipulator arm 5 at which it is attached to the manipulator base 3. It will be understood that in different embodiments also more than one mass element 13 may be provided and that the position of the one or more mass elements 13 may vary. Further, as shown in FIG. 1B, the mass element 13 is arranged at the left side of the manipulator base 3, spaced from the proximal side of the manipulator arm 5 to counteract a shift of the center of mass by the depicted manipulator arm configuration. As shown in FIGS. 1A and 1i, the movable arm 5 may have different orientations with respect to the manipulator base 3.

The orientations of the manipulator arm 5 may be set and controlled by the control means 7 of the mobile manipulator. In the depicted embodiment, the control means 7 is arranged at the mobile manipulator 1. However, it will be understood that in different embodiments, the control means 7 can also be arranged at least partially outside of or remote from the mobile manipulator 1. The control means 7 may comprise suitable sensing, computing and controlling means for controlling the elements of the mobile manipulator 1, for instance an orientation of the manipulator arm 5 or a propelling speed, acceleration and direction of the wheels. Dependent on the configuration of the manipulator arm 5, the center of mass of the mobile manipulator 1 changes. For instance, due to the manipulator arm configuration, the center of mass of the mobile manipulator 1 of the sub-figure B) is shifted more to the right compared to the center of mass of the manipulator 1 of FIG. 1A because the manipulator arm 5 in FIG. 1B extends further beyond and away from the manipulator base 3 compared to the configuration of FIG. 1A. As noted above, this is counteracted by the positioning of the mass element 13. In a different embodiment, a center of mass may be shifted by changing only a manipulator arm configuration, e.g. a position of the manipulator arm 5.

When the center of mass is shifted too far, the mobile manipulator 1 may be in an unstable condition such that a tipping of the mobile manipulator 1 may occur. This may be counteracted, for instance, by controlling the orientation of the manipulator arm 5 to one or more proper positions. Thus, when the mobile manipulator 1 moves along the predefined movement trajectory, for instance along different distinct paths of an industrial, scientific or medical site, the manipulator arm 5 may be controlled according to the present invention to assume different configurations to maintain stable condition during movement. This may include setting a first arm configuration at a first travel path or section and to set a different a second configuration at a second travel path or section.

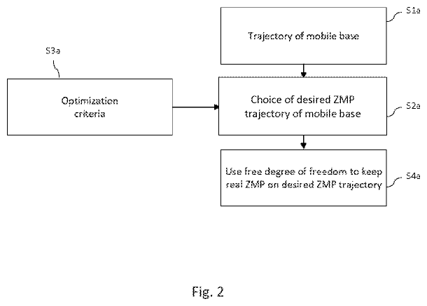

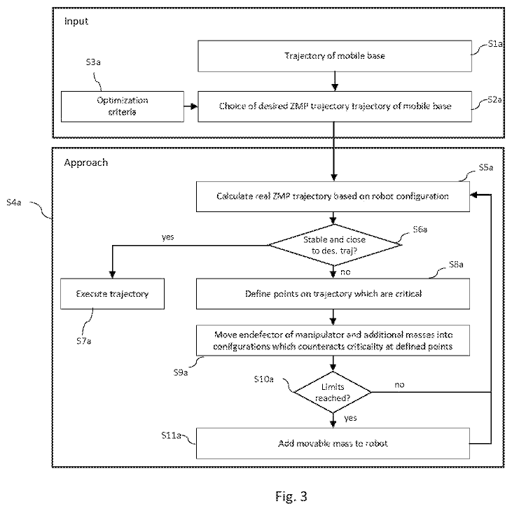

Further, a computer-program product 200 and a computer-readable medium 300 are shown, each comprising instructions, which, when executed by a computer 100, cause the computer 100 to carry out and/or control the method of any embodiments of the present invention, in particular the method as illustrated in FIGS. 2 and 3. In the depicted embodiment, the computer 100, the computer-program product 200 and the computer-readable medium 300 are depicted as external elements. However, it will be understood that in different embodiments, any of the computer 100, the computer-program product 200 and the computer-readable medium 300 may be at least partly integrated in the mobile manipulator 1.

FIG. 2 depicts a flowchart illustrating a method for controlling a mobile manipulator 1 according to an embodiment of the present invention. In step S1a of the depicted embodiment, a desired movement trajectory of the mobile base 3 or the mobile manipulator 1 is determined. In step S2a of the depicted embodiment, based on the desired movement trajectory, the desired ZMP trajectory of the mobile base 3 or the mobile manipulator 1 is chosen or determined. As shown in step S3a, optimization criteria may be introduced to improve the overall performance of the mobile manipulator 1. Such optimization criteria may be any suitable criteria for optimizing a mobile manipulator action such as, for instance, the requirement to employ the lowest possible acceleration or the highest possible speed or to reduce the power consumption of the mobile manipulator 1. In step S4a, which is explained in greater detail further below, the ZMP trajectory is used as input for the definition of the motion of the mobile manipulator 1 to exploit the redundant degrees of freedom. The free degrees of freedom can be accordingly used to keep the current ZMP trajectory of the mobile manipulator 1 on the desired ZMP trajectory of the mobile manipulator 1.

FIG. 3 depicts a flowchart illustrating a method for controlling a mobile manipulator 1 according to an embodiment of the present invention. As depicted, the steps S1a to S3a correspond to the steps S1a to S3a of FIG. 2, wherein the output of steps S1a to S3a form an input for the following steps. In FIG. 3 denoted as “approach”, the step S4a of FIG. 2 is explained in greater detail. Herein, the output of step S2a is used as an input for step S5a, wherein in step S5a the current or real ZMP trajectory of the mobile manipulator 1 is determined or predicted. Based on that determination, it is determined or predicted in step S6a, whether the current ZMP trajectory is a stable trajectory which corresponds or is close to the desired ZMP trajectory of the mobile base. If the answer is “yes”, the trajectory is executed in step S7a. If the answer is “no”, points of the desired movement trajectory of the mobile manipulator 1 for which the ZMP do not correspond to the desired that ZMP trajectory are determined or predicted in step S8a. In step S9a, the end effector and/or a manipulator arm and/or additional masses may then be accordingly adjusted or moved such that their changed position counteracts the criticality regarding a tipping or instable movement of the mobile manipulator 1 at the defined points.

Thus, the center of mass of the mobile manipulator 1 is accordingly adjusted by the respective movement of the manipulator arm 5 to avoid an unstable condition of the mobile manipulator 1 at the calculated critical points. Subsequently, in step S10a, it is determined or predicted whether the limits of a movement of the manipulator arm or the additional masses are reached. The answer is “no”, the method returns to step S5a, wherein the current ZMP trajectory of the mobile manipulator 1 is determined or predicted based on the adjusted setting. If the answer is “yes”, further additional masses may be added to the mobile manipulator to overcome an instability. Then, the method returns to step S5a, wherein the current ZMP trajectory of the mobile manipulator 1 is determined or predicted based on the adjusted setting.

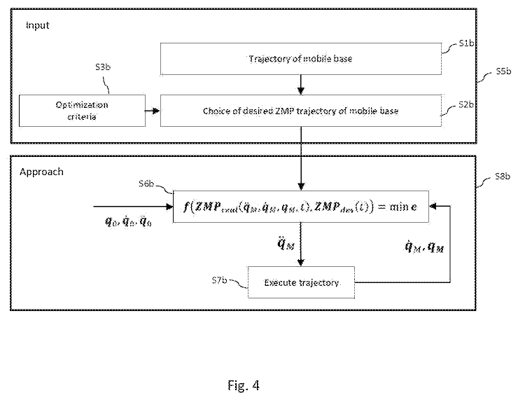

FIG. 4 depicts a flowchart illustrating a method for controlling a mobile manipulator 1 according to an embodiment of the present invention. As depicted, the steps S1b to S3b correspond to the steps S1a to S3a of FIG. 2, wherein the output of steps S1b to S3b form an input (S5b) for the following steps. In FIG. 4, denoted as “approach” (cf. S8b), one embodiment of the step S4a of FIG. 2 is explained in greater detail. Herein, the output of step S2b is used as an input for step S6b, wherein in step S6b the current or real ZMP trajectory of the mobile manipulator 1 is determined or predicted. A dynamic manipulator arm movement may be accordingly provided, which is controlled by the following first control function:

$$f ( Z M {P}_{real} ( {\ddot{q}}_{M} , {\dot{q}}_{M} , {q}_{M} , t ) , ZM {P}_{d e s} ( t ) ) = min e$$

wherein “ZMP_{des}(t)” is the desired ZMP trajectory; “ZMPᵣₑₐₗ” is the real ZMP trajectory; “t” is a time; “\ddot{q}_{M}, \dot{q}_{M}, q_{M},” are joint states of acceleration, velocity and position of the manipulator arm; and “e” is a deviation of the real ZMP trajectory from the desired ZMP trajectory.

From the first control function described in step S6b, the joint accelerations of the manipulator arm 5 “\ddot{q}_{M}” may be obtained as an output. Based on that output a movement trajectory of the mobile manipulator 1 is executed in step S7b. After executing the movement trajectory of the mobile manipulator 1 based on that output, the remaining states of position and velocity “q_{M}, \dot{q}_{M}” are used as an input for the first control function of step S6b. In a different embodiment, different outputs may be obtained, such as the state of velocity “\dot{q}_{M}” of the manipulator arm 5 or the state of position “q_{M}” of the manipulator arm 5 and an execution of the movement trajectory of the mobile manipulator 1 may be based on that different output. Accordingly, also different inputs may be used as an input for the first control function of step S6b, such as the state of acceleration “\ddot{q}_{M}” of the manipulator arm. As depicted, “q₀, \dot{q}₀, \ddot{q}₀”, which are the initial states of position, velocity and acceleration of the mobile manipulator 1 are used as further input variables for the first control function of step S6b.

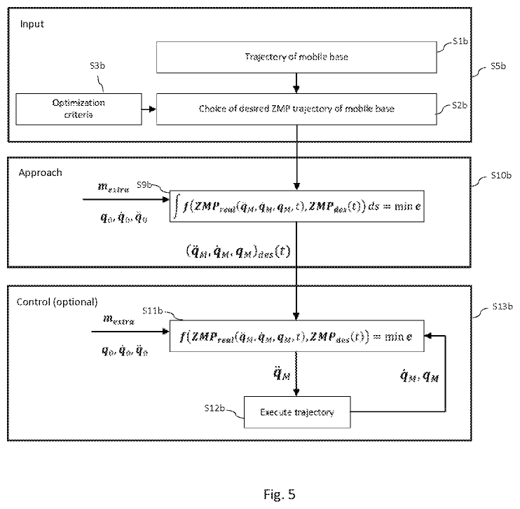

In FIG. 5, another embodiment for controlling a mobile manipulator 1 is depicted. Herein, the steps S1b to S3b correspond to the steps S1a to S3a of FIG. 2 and steps S1b to S3b of FIG. 4, and the output of steps S1b to S3b forms an input (cf. S5b denoted as “input”) for the following steps. In FIG. 5, denoted as “approach” (cf. S10b), one embodiment of the step S4a of FIG. 2 is explained in greater detail. Herein, the output of step S2b is used as an input for step S9b, wherein in step S9b, the current or real ZMP trajectory of the mobile manipulator 1 is determined or predicted. A dynamic manipulator arm movement may be accordingly provided, which is controlled by the following second control function of step S9b, which may be also referred to as planning function:

$$\int f ( {ZMP}_{real} ( {\ddot{q}}_{M} , {\dot{q}}_{M} , {q}_{M} , t ) , ZM {P}_{d e s} ( t ) ) ds = min e$$

From the second control function of step S9b, the desired state of the manipulator arm 5 “(\ddot{q}_{M}, \dot{q}_{M}, q_{M})_{des}(t)” can be obtained as an output. As depicted, “q₀, \dot{q}₀, \ddot{q}₀”, which are the initial states of position, velocity and acceleration of the mobile manipulator 1 are used as further input variables for the second control function S9b. Furthermore, a discrete mass parameter “mₑₓₜᵣₐ” can be used as an input variable for the second control function of step S9b. In a different embodiment, no discrete mass parameter “mₑₓₜᵣₐ” is used as an input variable for the second control function of step S9b. The output of the second control function of step S9b may optionally also be used as an input for a subsequent control approach (cf. S13b, denoted as “control (optional)”). Herein, the first control function of step S11b basically corresponds to the first control function of step S6b of FIG. 4. As depicted, “q₀, \dot{q}₀, \ddot{q}₀”, which are the initial states of position, velocity and acceleration of the mobile manipulator 1 are used as further input variables for the first control function of step S11b. Furthermore, a discrete mass parameter “mₑₓₜᵣₐ” can be used as an input variable for the first control function of step S11b. In a different embodiment, no discrete mass parameter “mₑₓₜᵣₐ” is used as an input variable for the first control function of step S11b.

Similar to the control approach of FIG. 4 (cf. S8b), from the first control function described in step S11b, the joint accelerations of the manipulator arm 5 “\ddot{q}_{M}” may be obtained as an output. Based on that output a movement trajectory of the mobile manipulator 1 is executed in step S12b. After executing the movement trajectory of the mobile manipulator 1 based on that output, the remaining states of position and velocity “q_{M}, \dot{q}_{M}” are used as an input for the first control function of step S11b. In a different embodiment, different outputs may be obtained, such as the state of velocity “\dot{q}_{M}” of the manipulator arm 5 or the state of position “q_{M}” of the manipulator arm 5 and an execution of the movement trajectory of the mobile manipulator 1 may be based on that different output. Accordingly, also different inputs may be used as an input for the first control function of step S11b, such as the state of acceleration “\ddot{q}_{M}” of the manipulator arm 5.

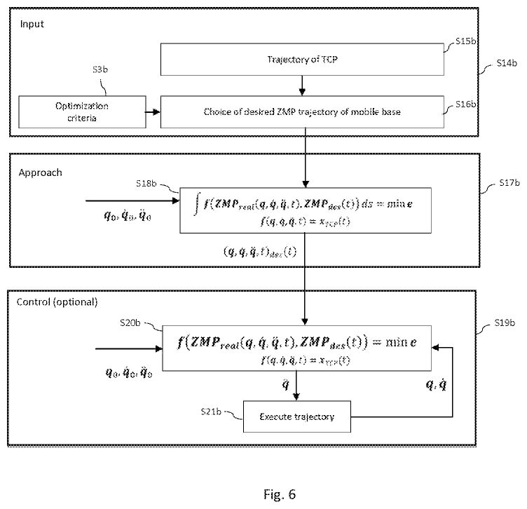

The control approach depicted in FIG. 6 basically corresponds to the control approach depicted in FIG. 5 with the difference that for the input (cf. S14b), the trajectory of a TCP is used (cf S15b) for the determination or choice of the desired ZMP trajectory (S16b). In FIG. 6, denoted as “approach” (cf. S17b), one embodiment of the step S4b of FIG. 2 is explained in greater detail. Herein, the output of step S16b is used as an input for step S18b, wherein in step S18b the current or real ZMP trajectory of the mobile manipulator 1 is determined or predicted. Contrary to the previous approach of FIG. 5, not only the movement of the manipulator arm is considered but the movement of the whole manipulator, including a movement of the manipulator arm 5 and the manipulator base 3.

Thus, a movement may be accordingly provided, which is controlled by the following second control function of step S18b, which may be also referred to as planning function:

$$\int f ( {ZMP}_{real} ( q , \dot{q} , \ddot{q} , t ) , {ZMP}_{des} ( t ) ) ds = mine$$

Different to the second control function of step S9b of FIG. 5, the TCP is controlled to execute a TCP-trajectory, according to the following function:

$$f ( q , \dot{q} , \ddot{q} , t ) = {x}_{TCP} ( t )$$

wherein “q, \dot{q}, \ddot{q}” are the joint states of position, velocity and acceleration of the mobile manipulator 1, and wherein χ_{TCP}(t) is the TCP-trajectory, and wherein the TCP-trajectory is used to determine the desired ZMP trajectory “ZAMP_{des}(t)”.

From the second control function of step S18b, the desired state of the mobile manipulator 1 “(\ddot{q}, \dot{q}, q)_{des}(t)” can be obtained as an output. As depicted, “q₀, \dot{q}₀, \ddot{q}₀”, which are the initial states of position, velocity and acceleration of the mobile manipulator 1 are used as further input variables for the second control function S18b. In a different embodiment, a discrete mass parameter “mₑₓₜᵣₐ” may be additionally used as an input variable for the second control function of step S18b (cf FIG. 5). The output of the second control function of step S18b may optionally also be used as an input for a subsequent control approach (cf. S19b, denoted as “control (optional)”), wherein in step S20b the current or real ZMP trajectory of the mobile manipulator 1 is determined or predicted. Herein, a dynamic manipulator movement may be provided, which is controlled by the following first control function:

$$f ( {ZMP}_{real} ( q , \dot{q} , \ddot{q} , t ) , {ZMP}_{des} ( t ) ) = mine$$

wherein “ZMP_{des}(t)” is the desired ZMP trajectory; “ZMPᵣₑₐₗ” is the real ZMP trajectory; “t” is a time; “q, \dot{q}, \ddot{q}” are the joint states of position, velocity and acceleration of the mobile manipulator 1 and “e” is a deviation of the real ZMP trajectory from the desired ZMP trajectory.

Herein, the first control function of step S20b basically corresponds to the first control function of step S6b of FIG. 4 and S11b of FIG. 5 with the difference that, the TCP is controlled to execute a TCP-trajectory, according to the following function:

$$f ( q , \dot{q} , \ddot{q} , t ) = {x}_{TCP} ( t )$$

As depicted, “q₀, \dot{q}₀, \ddot{q}₀”, which are the initial states of position, velocity and acceleration of the mobile manipulator 1 are used as further input variables for the first control function of step S20b. In a different embodiment, a discrete mass parameter “mₑₓₜᵣₐ” may be additionally used as an input variable for the first control function of step S20b (cf. FIG. 5).

Similar to the control approaches of FIG. 4 (cf. S8b) and FIG. 5 (cf. S13b), from the first control function described in step S20b, the joint accelerations of the mobile manipulator 1 “\ddot{q}” may be obtained as an output. Based on that output a movement trajectory of the mobile manipulator 1 is executed in step S21b. After executing the movement trajectory of the mobile manipulator 1 based on that output, the remaining states of position and velocity “q, \dot{q}” of the mobile manipulator 1 are used as an input for the first control function of step S20b. In a different embodiment, different outputs may be obtained, such as the state of velocity “\dot{q}” of the mobile manipulator 1 or the state of position “q” of the mobile manipulator 1 and an execution of the movement trajectory of the mobile manipulator 1 may be based on that different output. Accordingly, also different inputs may be used as an input for the first control function of step S20b, such as the state of acceleration “q” of the mobile manipulator 1.

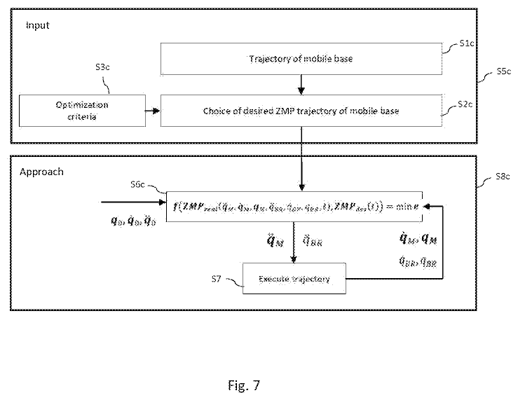

FIG. 7 depicts a flowchart illustrating a method for controlling a mobile manipulator 1 according to an embodiment of the present invention. As depicted, the steps S1c to S3c correspond to the steps S1a to S3a of FIG. 2, wherein the output of steps S1c to S3c form an input (S5c) for the following steps. In FIG. 7, denoted as “approach” (cf. S8c), one embodiment of the step S4a of FIG. 2 is explained in greater detail. Herein, the output of step S2c is used as an input for step S6c, wherein in step S6c the current or real ZMP trajectory of the mobile manipulator 1 is determined or predicted. A dynamic manipulator arm movement may be accordingly provided, which is controlled by the following first control function:

$$f ( {ZMP}_{real} ( {\ddot{q}}_{M} , {\dot{q}}_{M} , {q}_{M} , {\ddot{q}}_{BR} , {\dot{q}}_{BR} , {q}_{BR} , t ) , {ZMP}_{des} ( t ) ) = mine$$

wherein “ZMP_{des}(t)” is the desired ZMP trajectory; “ZMPᵣₑₐₗ” is the real ZMP trajectory; “t” is a time; “\ddot{q}_{M}, \dot{q}_{M}, q_{M},” are joint states of acceleration, velocity and position of the manipulator arm 5; “q_{BR}, \dot{q}_{BR}\ddot{q}_{BR}” are a rotational position, rotational velocity and rotational acceleration of the manipulator base 3, and “e” is a deviation of the real ZMP trajectory from the desired ZMP trajectory.

From the first control function described in step S6c, the joint accelerations of the manipulator arm 5 “\ddot{q}_{M}” and/or the rotational acceleration “\ddot{q}_{BR}” may be obtained as an output. Based on that output, a movement trajectory of the mobile manipulator 1 is executed in step S7c. After executing the movement trajectory of the mobile manipulator 1 based on that output, the remaining states of position and velocity “q_{M}, \dot{q}_{M}” and/or the rotational position and velocity “q_{BR}, \dot{q}_{BR}” of the manipulator base 3 are used as an input for the first control function of step S6c. In a different embodiment, different outputs may be obtained, such as the state of velocity “\dot{q}_{M}” of the manipulator arm 5 or the state of position “q_{M}” of the manipulator arm 5 and an execution of the movement trajectory of the mobile manipulator 1 may be based on that different output. Likewise, in a different embodiment, different outputs may be obtained, such as the rotational velocity “\dot{q}_{BR}” of the manipulator base 3 or the rotational position “q_{BR}” of the manipulator base 3 and an execution of the movement trajectory of the mobile manipulator 1 may be based on that different output. Accordingly, also different inputs may be used as an input for the first control function of step S6c, such as the state of acceleration “\ddot{q}_{M}” of the manipulator arm 5 and/or the rotational acceleration “\ddot{q}_{BR}” of the manipulator base 3. As depicted, “q, \dot{q}₀, \ddot{q}₀”, which are the initial states of position, velocity and acceleration of the mobile manipulator 1 are used as further input variables for the first control function of step S6c.

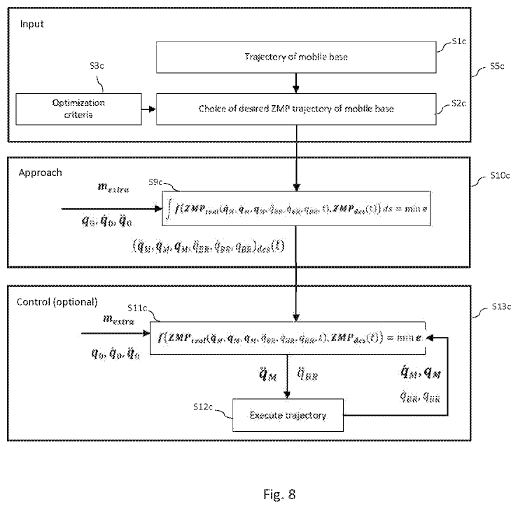

In FIG. 8, another embodiment for controlling a mobile manipulator 1 is depicted. Herein, the steps S1c to S3c correspond to the steps S1a to S3a of FIG. 2 and the steps S1c to S3c of 7, and the output of steps S1c to S3c forms an input (cf. S5c denoted as “input”) for the following steps. In FIG. 8, denoted as “approach” (cf. S10c), one embodiment of the step S4a of FIG. 2 is explained in greater detail. Herein, the output of step S2c is used as an input for step S9c, wherein in step S9c, the current or real ZMP trajectory of the mobile manipulator 1 is determined or predicted. A dynamic manipulator arm movement and/or a rotational movement of the manipulator base 3 may be accordingly provided, which is controlled by the following second control function of step S9c, which may be also referred to as planning function:

$$\int f ( {ZMP}_{real} ( {\ddot{q}}_{M} , {\dot{q}}_{M} , {q}_{M} , {\ddot{q}}_{BR} , {\dot{q}}_{BR} , {q}_{BR} , t ) , {ZMP}_{des} ( t ) ) ds = mine$$

From the second control function of step S9c, the desired state of the manipulator arm 5 “(\ddot{q}_{M}, \dot{q}_{M}, q_{M}, \dot{q}_{BR}, q_{BR})_{des}(t)” can be obtained as an output. As depicted, “q₀, \dot{q}₀, \ddot{q}₀”, which are the initial states of position, velocity and acceleration of the mobile manipulator 1 are used as further input variables for the second control function S9c. Furthermore, a discrete mass parameter “mₑₓₜᵣₐ” can be used as an input variable for the second control function of step S9c. In a different embodiment, no discrete mass parameter “mₑₓₜᵣₐ” is used as an input variable for the second control function of step S9c. The output of the second control function of step S9c may optionally also be used as an input for a subsequent control approach (cf. S13c, denoted as “control (optional)”). Herein, the first control function of step S11c basically corresponds to the first control function of step S6c of FIG. 7. As depicted, “q₀, \dot{q}₀, \ddot{q}₀”, which are the initial states of position, velocity and acceleration of the mobile manipulator 1 are used as further input variables for the first control function of step S11c. Furthermore, a discrete mass parameter “mₑₓₜᵣₐ” can be used as an input variable for the first control function of step S11c. In a different embodiment, no discrete mass parameter “mₑₓₜᵣₐ” is used as an input variable for the first control function of step S11c.

Similar to the control approach of FIG. 7 (cf. S8c), from the first control function described in step S11c, the joint accelerations of the manipulator arm 5 “\ddot{q}_{M}” and/or the rotational acceleration “\ddot{q}_{BR}” of the manipulator base 3 may be obtained as an output. Based on that output a movement trajectory of the mobile manipulator 1 is executed in step S12c. After executing the movement trajectory of the mobile manipulator 1 based on that output, the remaining states of position and velocity “q_{M}, \dot{q}_{M}” and/or the rotational position and velocity “q_{BR}, \dot{q}_{BR}” are used as an input for the first control function of step S11c. In a different embodiment, different outputs may be obtained, such as the state of velocity “\dot{q}_{M}” of the manipulator arm 5 or the state of position “q_{M}” of the manipulator arm 5 and an execution of the movement trajectory of the mobile manipulator 1 may be based on that different output. Likewise, in a different embodiment, different outputs may be obtained, such as the rotational velocity “\dot{q}_{BR}” of the manipulator base 3 or the rotational position “q_{BR}” of the manipulator base 3 and an execution of the movement trajectory of the mobile manipulator 1 may be based on that different output. Accordingly, also different inputs may be used as an input for the first control function of step S11c, such as the state of acceleration “\ddot{q}_{M}” of the manipulator arm 5 and/or the rotational acceleration “\ddot{q}_{BR}” of the manipulator base 3.

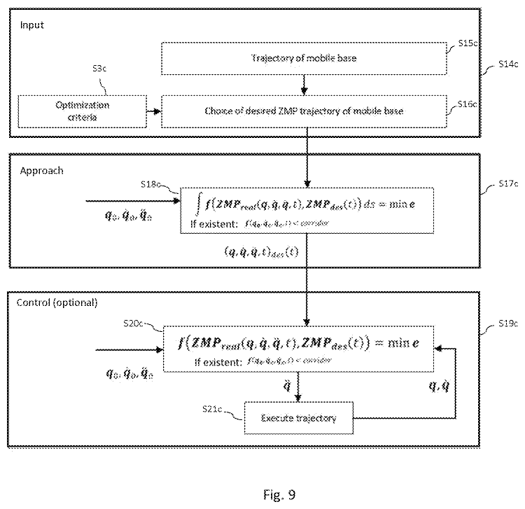

The control approach depicted in FIG. 9 basically corresponds to the control approach depicted in FIG. 8 with the difference that in FIG. 9 the movement is restricted by spatial constraint such as a corridor. In FIG. 9, denoted as “approach” (cf. S17c), one embodiment of the step S4a of FIG. 2 is explained in greater detail. Herein, the output of step S16c is used as an input for step S18c, wherein in step S18c the current or real ZMP trajectory of the mobile manipulator 1 is determined or predicted. Contrary to the previous approach of FIG. 8, not only the movement of the manipulator arm is considered but the movement of the whole manipulator, including a movement of the manipulator arm 5 and the manipulator base 3.

Thus, a movement may be accordingly provided, which is controlled by the following second control function of step S18c, which may be also referred to as planning function:

$$\int f ( {ZMP}_{real} ( q , \dot{q} , \ddot{q} , t ) , {ZMP}_{des} ( t ) ) ds = mine$$

Different to the second control function of step S9c of FIG. 8, when the movement of the mobile manipulator is delimited by a corridor, the second control function comprise an additional constraint:

$$f ( {q}_{B} , {\dot{q}}_{B} , {\ddot{q}}_{B} , t ) < corridor$$

wherein “q_{B}, \dot{q}_{B}, \ddot{q}_{B}” are the degrees of freedom of the position, the velocity and the acceleration of the manipulator base 3 and “corridor” is a constraint value defined by the dimensions of the corridor the mobile manipulator 1 is moving through.

From the second control function of step S18c, the desired state of the mobile manipulator 1 “(\ddot{q}, \dot{q}, q)_{des}(t)” can be obtained as an output. As depicted, “q₀, \dot{q}₀, \ddot{q}₀”, which are the initial states of position, velocity and acceleration of the mobile manipulator 1 are used as further input variables for the second control function S18c. In a different embodiment, a discrete mass parameter “mₑₓₜᵣₐ” may be additionally used as an input variable for the second control function of step S18c (cf. FIG. 8). The output of the second control function of step S18c may optionally also be used as an input for a subsequent control approach (cf. S19c, denoted as “control (optional)”), wherein in step S20c the current or real ZMP trajectory of the mobile manipulator 1 is determined or predicted. Herein, a dynamic manipulator movement could be provided, which is controlled by the following first control function:

$$f ( {ZMP}_{real} ( q , \dot{q} , \ddot{q} , t ) , {ZMP}_{des} ( t ) ) = mine$$

wherein “ZMP_{des}(t)” is the desired ZMP trajectory; “ZMPᵣₑₐₗ” is the real ZMP trajectory; “t” is a time; “q, \dot{q}, \ddot{q}” are the joint states of position, velocity and acceleration of the mobile manipulator 1 and “e” is a deviation of the real ZMP trajectory from the desired ZMP trajectory.

Herein, the first control function of step S20c basically corresponds to the first control function of step S6c of FIG. 7 and S11c of FIG. 8 with the difference that, when the movement of the mobile manipulator 1 is delimited by a corridor, the first control function comprise the additional constraint:

$$f ( {q}_{B} , {\dot{q}}_{B} , {\ddot{q}}_{B} , t ) < corridor$$

As depicted, “q₀, \dot{q}₀, \ddot{q}₀”, which are the initial states of position, velocity and acceleration of the mobile manipulator 1 are used as further input variables for the first control function of step S20c. In a different embodiment, a discrete mass parameter “mₑₓₜᵣₐ” may be additionally used as an input variable for the first control function of step S20c (cf. FIG. 8).

Similar to the control approaches of FIG. 7 (cf. S8c) and FIG. 8 (cf. S13c), from the first control function described in step S20c, the joint accelerations of the mobile manipulator 1 “\ddot{q}” may be obtained as an output. Based on that output a movement trajectory of the mobile manipulator 1 is executed in step S21c. After executing the movement trajectory of the mobile manipulator 1 based on that output, the remaining states of position and velocity “q, \dot{q}” of the mobile manipulator 1 are used as an input for the first control function of step S20c. In a different embodiment, different outputs may be obtained, such as the state of velocity “\dot{q}” of the mobile manipulator 1 or the state of position “q” of the mobile manipulator 1 and an execution of the movement trajectory of the mobile manipulator 1 may be based on that different output. Accordingly, also different inputs may be used as an input for the first control function of step S20c, such as the state of acceleration “\ddot{q}” of the mobile manipulator 1.

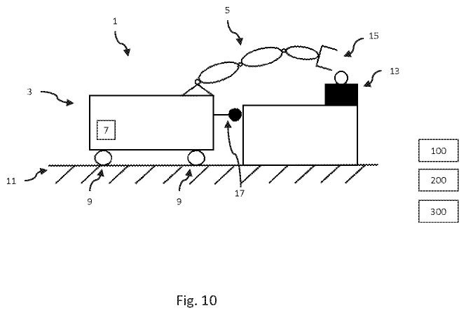

FIG. 10 depicts a mobile manipulator 1 according to the present invention. The mobile manipulator 1 comprises a manipulator base 3 and a manipulator arm 5 attached at the top side of mobile base 3. It will be understood that in different embodiments, more than one manipulator arm 5 may be provided and that the position of the one or more manipulator arms 5 may vary, e.g. the manipulator arm 5 may be provided at the front or back side or at a lateral side of the mobile manipulator 1. The mobile manipulator arm 5 is formed as a movable arm comprising multiple arm elements which are linked together to allow a flexible movement and an extension or retraction of the arm. However, it will be understood that in different environments also a stiff manipulator arm may be provided consisting, for instance, only of a single stiff-arm element movably attached to the manipulator base 3. The manipulator arm 5 is hinged at a proximal end of the manipulator arm 5 with the mobile phase 3 and comprises a TCP 15 at the distal end of the manipulator arm 5. In the depicted embodiment, the TCP 15 is formed as a gripper to allow a grip and lift of an external mass element or load 13. The manipulator base 3 comprises contact elements 9 in form of wheels to contact the floor 11. Thus, the mobile manipulator 1 may be moved along the floor 11 along a predefined movement trajectory. The mobile manipulator 1 further comprises an external stabilizing device in form of a telescopic arm 17. In the depicted configuration, the telescopic arm 17 extends from the front side of the manipulator base 3 and contacts a wall of a support platform, upon which the mass element 13 is arranged. Accordingly, when the mobile manipulator arm 5 picks up the mass element 13, the mobile manipulator 1 is stabilized by the telescopic arm 17 and therefore does not tip over. The orientations of the manipulator arm 5 and/or the telescopic arm 17 may be set and controlled by the control means 7 of the mobile manipulator 1. In the depicted embodiment, the control means 7 is arranged at the mobile manipulator 1. However, it will be understood that in different embodiments, the control means 7 can also be arranged at least partially outside of or remote to the mobile manipulator 1. The control means 7 may comprise suitable sensing, computing and controlling means for controlling the elements of the mobile manipulator 1. This may include, for instance, the control of an orientation of the manipulator arm 5 and/or the telescopic arm 17 or a propelling speed, acceleration and direction of movement of the wheels. Dependent on the configuration of the manipulator arm 5 and/or the telescopic arm 17, the center of mass of the mobile manipulator 1 changes. For instance, in the depicted embodiment, due to the manipulator arm configuration, the center of mass of the mobile manipulator 1 is shifted to the right because the manipulator arm 5 extends beyond and away from the manipulator base 3. As noted above, this can be counteracted by the contact of the telescopic arm 17, which accordingly increases the support surface of the mobile manipulator 1.

Further, a computer-program product 200 and a computer-readable medium 300 are shown, each comprising instructions, which, when executed by a computer 100, cause the computer 100 to carry out and/or control the method of any embodiments of the present invention, in particular the method as illustrated in FIG. 2. In the depicted embodiment, the computer 100, the computer-program product 200 and the computer-readable medium 300 are depicted as external elements. However, it will be understood that in different embodiments, any of the computer 100, the computer-program product 200 and the computer-readable medium 300 may be at least partly integrated in the mobile manipulator 1.

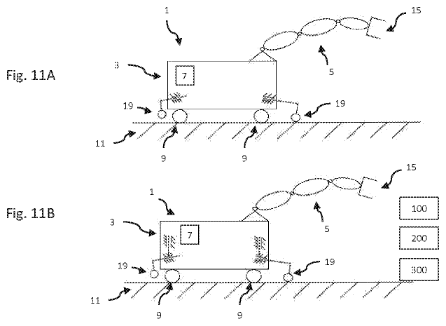

FIGS. 11A and 11B depict a different embodiment of the mobile manipulator 1. In this embodiment, the same elements of the mobile manipulator 1 as described for the embodiment of FIG. 10 are provided and it is accordingly referred thereto, with the difference that, instead of the telescopic arm 17, additional support wheels 19 are provided. When the mobile manipulator 1 becomes unstable, for instance due to a shift of the center of mass caused by a respective extension of the manipulator arm 5 to the right beyond the manipulator base 3, the support wheels 19 may be activated. Thus, the support polygon of the mobile manipulator 1 could be increased and the mobile manipulator one could be accordingly stabilized. In FIG. 1A, the support wheels 19 comprise one degree of freedom, namely the extension of the wheels away from the manipulator base 3. Thus, a respective distance of the support wheels 19 to the mobile manipulator 1 can be defined. In FIG. 11B, the support wheels 19 comprise two degrees of freedom, namely the extension of the wheels away from the manipulator base 3 and a height of the support wheels 19 with respect to the ground 11. Thus, the support wheels 19 may be accordingly adjusted in two dimensions.

It will be understood that the method according to the present invention is not limited to the above noted order of method steps. Quite to the contrary, the method steps may be also provided in a different order and one or more of the above noted method steps may be removed or further method steps may be added, as desired.

In the context of the present disclosure, the control of the external standardizing device may be performed by respective control means of the mobile manipulator. The control means may be arranged at the mobile manipulator or at least partially outside and remote to the mobile manipulator. The control means may comprise suitable computing and controlling means for controlling any elements of the mobile manipulator, for instance an orientation or extension of the manipulator arm and/or a propelling speed, acceleration or a steering of, for instance, wheels of the mobile manipulator. The control means may comprise respective sensors or detectors to determine a position, movement or acceleration of respective elements of the mobile manipulator, such as of the manipulator arm, of the manipulator base and further elements provided with the mobile manipulator. The determination of any configuration of the mobile manipulator and/or the determination or prediction of any parameters, such as the current configuration of the mobile manipulator, the desired movement trajectory, the determination of the ZMP, the current or desired ZMP trajectory and so forth, may be performed by respective computational means, which may or may not be part of control means of the mobile manipulator. The mobile manipulator may comprise one or more tools arranged at the distal end of the manipulator arm to perform respective manipulating actions, such as for instance picking and lifting an item and transporting and placing said item at a different position.

The mobile manipulator may be any kind of movable robot. “Mobile” or “movable” manipulators in this context may be understood such that the manipulator may assume different positions or locations on the ground. The position of the mobile manipulator may be accordingly changed. For instance, the mobile manipulator may move itself or is moved by respective means from a starting point to an end point via a predetermined distinct travel path.

The manipulator arm may be any type of mechanical arm. The manipulator arm may comprise multiple elements linked with each other and the mobile base to form a kinematic chain. The links of such a manipulator arm may be connected by respective joints allowing, for instance, a rotational motion or a linear translational displacement. However, it will be understood that the manipulator arm may also comprise only one stiff element linked to the manipulator base. The manipulator arm may be programmable for allowing execution of respective movements for performing different tasks. Also, more than one manipulator arm may be provided.

The manipulator base may essentially define the core body of the mobile manipulator, at which the manipulator arm is attached. The manipulator base may house respective propelling or controlling means such as the power supply, one or more motors and/or computing devices, which may be enclosed by a housing to protect the mobile manipulator elements arranged inside from negative impacts, such as dust and moisture. The manipulator base may define the support polygon. The support polygon may be a surface area upon which the mobile manipulator is supported or carried on the ground. The support polygon may comprise three, four or more edges or may have a circular, oval or of any other two-dimensional shape.

The current configuration of the mobile manipulator may include information about the extension and/or the weight of the respective parts of the mobile manipulator. For instance, the current configuration may include information about a center of mass of each component and/or the whole mobile manipulator. The center of mass of the mobile manipulator may comprise the masses and dimensions of the whole mobile manipulator or may only comprise masses and dimensions of individual parts. This may be, for instance, the largest parts or parts, which have the largest impact on the position of the center of mass of the mobile manipulator.

The manipulator arm configuration may include an extension or orientation of the manipulator arm with respect to the manipulator base, e.g., an angle of rotation or an extension of the manipulator arm and information about the weight or item the manipulator arm carries. The manipulator base configuration may include information about the manipulator bases' weight or the dimensions of the manipulator base, such as, for instance, the dimension of a lower base surface of the manipulator base, which may form the support polygon. Any suitable parameter concerning the center of mass of the mobile manipulator may be included.

The location at which the manipulator arm is attached to the manipulator base may be fixed or may vary. The manipulator arm may be provided at any desired side of the manipulator base, for instance at a top side, a front or back side, or at one of the lateral sides of the mobile manipulator. The manipulator arm configuration may include a distinct position and/or orientation of the manipulator arm in space, such as an arm stance. The manipulator arm configuration may comprise an information about the rotational position of the manipulator arm or an extension of the manipulator arm, e.g., an extension beyond the manipulator base. The manipulator base configuration may accordingly comprise a spatial extension and a weight or weight distribution of the manipulator base.

The desired movement trajectory may be a trajectory or path the mobile manipulator may take on a ground. Thus, the desired movement trajectory may be provided in an essentially horizontal two-dimensional plane. The mobile manipulator may move on the ground along the desired movement trajectory from a start position to an intermediate or end-position. The desired movement trajectory may be based on one or more tasks the mobile manipulator should perform, e.g. to pick up in item at a first position and to place said item at a second position. Or the desired movement trajectory may be based on movement of the manipulator arm performing a certain task to pick up an item at a first position and to place said item the same position. The movement trajectory may comprise one or more straight movements or curved movements, or any other arbitrary geometrical movement, for instance a movement on the ground between the start position and the end-position. The desired movement trajectory may comprise intermediate positions, at which the mobile manipulator may change its direction of motion. For instance, the mobile manipulator may pick up an item at a start position and move along the desired movement trajectory towards an end position to drop said item at this end position. The mobile manipulator may accordingly continue to a third point with or without picking up the same or a different item and/or may return to its start position.

A ZMP may be understood as a point at which reaction forces of a contact between mobile manipulator and the ground do not produce any moment in the horizontal direction, i.e., in a direction of a plane in which the mobile manipulator moves. This may be a direction in a plane essentially perpendicular to a direction of gravity. In a common notation, a plane in which the mobile manipulator moves, may extend in a x-y-direction and the direction of gravity is in a z-direction. The ZMP may be considered as the point where the sum of horizontal moments Mₓ, and M_{y} is zero. In other words, the ZMP may be defined as the reference point in the contact plane between robot and ground, for which the horizontal components of the contact moment vanish. The ZMP of the mobile manipulator may depend on the manipulator arm configuration, the manipulator base configuration, e.g. the extension of the support polygon, and the desired movement trajectory. One or more ZMP may be determined or predicted for the mobile manipulator. A determination may also be understood as a prediction in the current disclosure. Any ZMP may depend on a configuration of the mobile base and the manipulator arm including, for instance, a weight and spatial extension of said components and their respective arrangement with respect to each other.

Based on the current configuration of the mobile manipulator, a current ZMP trajectory may be determined or predicted. The current ZMP trajectory may correspond to one or more predicted ZMP locations of the mobile manipulator when the mobile manipulator would move along the desired movement trajectory. The mobile manipulator may be considered stable when its predicted current ZMP are located within the support polygon. If the one or more predicted current ZMP of the mobile manipulator are arranged in the support polygon, the mobile manipulator may be stable such that no tipping over may occur during the movement along the desired movement trajectory. Thus, in the method of the present invention, the mobile manipulator may be preferably configured such that its ZMP are located in the support polygon, thus allowing for a stable movement or standstill.

Accordingly, knowing the desired movement trajectory of the mobile manipulator and considering the mobile manipulators' configuration, e.g., based on the arm configuration, a desired ZMP trajectory may be determined or predicted, which may allow for a stable movement of the mobile manipulator when moving along the desired movement trajectory or a stable reaching out of the manipulator arm and picking and placing of a weight. If the mobile manipulator would move along the desired movement trajectory, and its ZMP correspond or are sufficiently close to the desired ZMP trajectory, stable movement of the mobile manipulator may be achieved.

Thus, the mobile manipulator may be accordingly adjusted such that the current ZMP trajectory may correspond or may be close to the desired ZMP trajectory to achieve a stable movement of the mobile manipulator. This adjustment may be performed before or during the movement of the mobile manipulator. For different sections of the movement trajectory, different adjustments of the mobile manipulator may be provided to obtain stable configuration. The adjustment may be similarly performed when the mobile manipulator is standing still and moving just the manipulator arm. For instance, if a ZMP would lie outside or is too far away from the desired ZMP trajectory, a mobile manipulator might accordingly become unstable during movement of the manipulator base and/or manipulator arm.

The selection of the respective stabilization methods may be performed manually or automatically and may consider constraints or limits of the respective method and/or the mobile manipulator. For instance, the mobile manipulator may have a distinct configuration for which a selected stabilization method may be suited best. As an example, the mobile manipulator may allow an omnidirectional movement including a translational and rotational movement of the manipulator base. Thus, in case one of the stabilization methods considers this particular configuration of the mobile manipulator, it may be accordingly selected from the group of stabilization methods. In another example, the mobile manipulator should move through corridor and the respective stabilization method may accordingly be suitable to take this constraint into account. In other words, a stabilization method may be selected, which suits best to stabilize the mobile manipulator considering, for instance, the configuration of the mobile manipulator, the tasks of the mobile manipulator to be executed and/or the environment of the mobile manipulator. The group of stabilization methods may each comprise respective predefined controls for the manipulator, which may be stored, for instance at respective digital storage means of the mobile manipulator. The group of stabilization methods may comprise two or more stabilization methods.

In a preferred embodiment, when the real ZMP trajectory of the mobile manipulator does not correspond to the desired ZMP trajectory, the method further comprises the steps of: selecting a different stabilization method out of the group of stabilization methods and adjust the mobile manipulator based on the selected different stabilization method, determining if the real ZMP trajectory of the mobile manipulator corresponds to the desired ZMP trajectory, and when the real ZMP trajectory of the mobile manipulator corresponds to the desired ZMP trajectory, the method further comprises the step of: executing a movement trajectory of the mobile manipulator, wherein the method preferably includes the step of: repeating the steps for adjusting the mobile manipulator based on one or more different stabilization methods of the group of stabilization methods until the real ZMP trajectory of the mobile manipulator corresponds to the desired ZMP trajectory.

Thus, a particular flexible method for stabilizing the mobile manipulator may be obtained. Different approaches to stabilizing the mobile manipulator may be accordingly considered, and respective stabilization methods may be combined by subsequently selecting the respective stabilization methods. This may be particularly helpful, if one stabilization method has, for instance, reached its limits, such that no further stabilization can be obtained by said stabilization method. Then, another stabilization method may be selected and executed to further stabilize the mobile manipulator.

In a preferred embodiment, the stabilization methods are hierarchically ordered, and the selection of the stabilization method is performed according to the hierarchical order.

The hierarchical order may be based on one or more preference criteria, wherein the stabilization method which has the highest preference may be accordingly selected first. The preference criteria may, for instance, depend on the configuration of the mobile manipulator, the tasks of the mobile manipulator to be executed and/or the environment of the mobile manipulator. For instance, if the mobile manipulator may have a limited energy supply, respective energy-saving stabilization methods may be selected over energy consuming stabilization methods. Or, in another example, a stabilization method may be considered to have the highest hierarchical order because it may provide the best stabilization for the mobile manipulator, which may have a certain weight or dimensions. The mobile manipulator may comprise accordingly means to determine a suitable hierarchical order. The hierarchical order may be a fixed order or may be an order that could be dynamically changed.

In another embodiment, the selection of the stabilization method out of the group of stabilization methods may be performed according to a mixed integer optimization problem, which may be solvable for one option out of the finite set of options using an overall cost function.

In a preferred embodiment, the step of adjusting the mobile manipulator is based on a first stabilization method comprising the step of adjusting a center of mass of the mobile manipulator including an adjustment of the manipulator arm configuration.

Accordingly, an improved method for stabilizing mobile manipulators during the movement along a distinct path may be provided, which may ensure that the mobile manipulator stays stable and does not tip over during the movement. The manipulator arm configuration may be essentially fixed or predetermined during the movement along certain sections of the desired movement trajectory. A suitable adjustment of the mobile manipulator, e.g. regarding the manipulator arm, may be determined and performed. The manipulator arm may be, for instance, adjusted in its orientation or position from a first position to a second position, such that a center of mass, and accordingly the ZMP of the mobile manipulator, may be shifted towards a more central position of the mobile manipulator, thus providing an increased stability. The mobile manipulator may be accordingly adjusted such that it might be no longer unstable when it would move along the desired movement trajectory. In some examples, the adjustment of the mobile manipulator may include an adjustment of the manipulator arm, e.g. a certain rotation of the arm, to shift the center of mass. Or the adjustment of the mobile manipulator may include an adjustment of an extension or reach of the manipulator arm with respect to the manipulator base to avoid a tipping over of the mobile manipulator. Further adjustments may consider the addition, removal or change of position of weight associated with the mobile manipulator.

In one example of the first stabilization method, the method may comprise the steps of determining critical points along the desired movement trajectory at which the mobile manipulator becomes unstable and may adjust the center of mass of the mobile manipulator to counteract the determined instability such that the mobile manipulator no longer becomes instable at the critical points.

Thus, an efficient and reliable method for providing a stable movement of the mobile manipulator may be achieved, which may be adapted to any desired movement of the mobile manipulator. Critical points may include points or locations along the movement trajectory, at which the center of mass may change due to, for instance, picking up additional weight or changing a stance of the mobile manipulator arm or may be points at which the mobile manipulator accelerates, breaks, or performs a change of direction. The adjustment of the center of mass may be accordingly sufficient to achieve stability of the mobile manipulator along at least parts of, preferably along the whole, movement trajectory, in particular at the critical points. The determination or prediction of critical points may also include also not only single points but also sections of the path or movement trajectory of the mobile manipulator for which the center of mass may be properly adjusted to allow a stable movement.

In one example of the first stabilization method, the manipulator base may comprise one or more contact elements configured to contact a ground upon which the mobile manipulator is movable, wherein the contact elements may preferably comprise one or more wheels.

Thus, a stable stand on the ground of the manipulator base during movement or standstill may be achieved. The manipulator base may comprise at least three contact elements. However, also a different number of contact elements may be provided. The support polygon may be accordingly defined by an area spanned between the contact elements contacting the ground. The ZMP may be accordingly adjusted to be located essentially in this contact area to allow a stable movement or stand of the mobile manipulator. Providing wheels may allow the mobile manipulator to be easily steered along the ground in one or more desired directions. One or more of the wheels may be actively steerable by respective controls and propelling means of the mobile manipulator or may rotate passively. The present invention may not be limited to wheels but may also comprise any type of steerable or non-steerable elements that may allow a movement of the mobile manipulator on the ground.

In one example of the first stabilization method, the step of determining the desired movement trajectory of the mobile manipulator may include a determination of a movement path of the mobile manipulator and/or a determination of an acceleration of the mobile manipulator.

Thus, one or more of the movement paths or the acceleration of the mobile manipulator may be considered for the adjustment of the mobile manipulator. The acceleration may be defined and known in advance over the whole path, which may facilitate the adjustment of the mobile manipulator to obtain stability. However, also different parameters may be considered in advance, such as the velocity, for instance the maximum velocity, of the mobile manipulator, which may be considered known in advance. Each of the parameters may be, for instance, considered being fixed to a certain value, such as a minimum or maximum value.

In one example of the first stabilization method, the step of adjusting the center of mass of the mobile manipulator may include an adjustment of the configuration of the manipulator arm to one or more manipulator arm configurations, wherein the manipulator arm may be preferably moved from one manipulator arm configuration to another manipulator arm configuration to adjust the center of mass of the mobile manipulator.

Thus, the center of mass of the mobile manipulator may be easily adjusted in stability, for instance, without the employment of further additional weights. The adjustment may include an iterative movement of the manipulator arm to one or more different positions. The adjustment may include moving the manipulator arm to one or more fixed arm configurations. For the adjustment, the movement trajectory or path of the mobile manipulator and the acceleration along said path may be known. A respective fixed arm configuration, which may be a pre-defined arm configuration for the whole path or for one or more sections of the path, may be considered for the determination or calculation of the ZMP of the mobile manipulator. The adjustment of the center of mass may be performed during a movement of the mobile manipulator or may be performed at a standstill of the mobile manipulator, for instance before the mobile manipulator starts to move or between two critical points. The movement of the arm may be preferably a slow movement to avoid dynamic force influences. The adjustment of the manipulator arm may be performed when the mobile manipulator is in a stable resting position, for instance before it begins to move along the movement trajectory.

In a preferred embodiment, the step of adjusting the mobile manipulator is based on a second stabilization method comprising the step of adjusting a center of mass of the mobile manipulator, wherein the mobile manipulator comprises one or more variable mass elements, and wherein the step of adjusting the center of mass of the mobile manipulator includes an adjustment of the variable mass elements.

Thus, the mobile manipulator could be adjusted in addition or alternatively to the adjustment of the arm configuration of the mobile manipulator, which may increase the flexibility, and which may extend the limits of the stabilizing adjustment. The variable mass elements may be positioned at different distinct positions the mobile manipulator to influence and adjust the center of mass of the mobile manipulator. The variable mass element may comprise a fixed weight or may have a variable weight, which may be adapted. The variable mass element may be a single mass element or may comprise multiple mass elements, which may be individually adjustable. Further, also a plurality of different weights may be provided depending on the need for adjustment of the mobile manipulator. The mass elements may be provided at any suitable position at the mobile manipulator, e.g. at an outer side of a housing, for instance at the top side or inside a housing the mobile manipulator. The mass elements may be adjusted manually by a user or automatically to one or more positions. The mass elements may be suitably adapted to the weight or dimensions of the mobile manipulator, for instance in a way that a proper stabilization of the mobile manipulator could be achieved while avoiding unnecessary weight.

In one example of the second stabilization method, the variable mass elements may include one or more external mass elements that are removably arrangeable at the mobile manipulator and the step of adjusting the center of mass of the mobile manipulator may include adding or removing the external variable mass elements to the mobile manipulator. Additionally, or alternatively, the variable mass elements may include one or more internal mass elements that are non-removably arrangeable at different positions at the mobile manipulator and the step of adjusting the center of mass of the mobile manipulator may include varying the positions of the internal variable mass elements. Thus, a particular precise and efficient adjustment of the center of mass may be achieved.

An external mass element may be understood as a mass element that is not immediately associated with respect to the mobile manipulator but can be added or removed, as desired. As an example, a tool or grip arranged at a distal end of the manipulator arm, e.g. at a tool center point, may grip a weight to adjust the center of mass of the mobile manipulator. If the manipulator picks up a certain weight during his tasks, said additional weight may be accordingly considered for the adjustment of the center of mass. External mass elements may include any type of additional weights or masses, that could be conveniently added or removed manually or automatically with respect to the mobile manipulator.

Contrary to this, internal mass elements may be understood as mass elements which may be more or less immediately associated with the mobile manipulator. This may include mass elements which may be fixedly or movably arranged or mounted inside or outside of a housing of the mobile manipulator. The internal mass elements may be, for instance, arranged on respective rails arranged at the mobile manipulator to allow a simple and defined positioning of said weights.

The movement of internal and external mass elements may be accordingly sensed and controlled by respective sensing and control means of the mobile manipulator. The positioning of the internal and external mass elements may be performed along any desired direction. The movement of the variable mass elements may be performed by moving the mass elements along one or more pre-defined movement trajectories with respect to the mobile manipulator. Also, a combination of external and internal mass elements may be provided and the adjustment of the center of mass of the mobile manipulator may be accordingly performed based on an individual or joint adjustment of the external and internal mass elements.

In a preferred embodiment, the step of adjusting the mobile manipulator is based on a third stabilization method comprising a dynamic manipulator arm movement, which is controlled based on the following first control function:

$$f ( {ZMP}_{real} ( {\ddot{q}}_{M} , {\dot{q}}_{M} , {q}_{M} , t ) , {ZMP}_{des} ( t ) ) = mine$$

and/or based on the following second control function:

$$\int f ( {ZMP}_{real} ( {\ddot{q}}_{M} , {\dot{q}}_{M} , {q}_{M} , t ) , {ZMP}_{des} ( t ) ) ds = mine$$

wherein “ZMP_{des}(t)” is the desired ZMP trajectory; “ZMPᵣₑₐₗ” is the real ZMP trajectory; “t” is a time; “\ddot{q}_{M}, \dot{q}_{M}, q_{M},” are joint states of acceleration, velocity and position of the manipulator arm; and “e” is a deviation of the real ZMP trajectory from the desired ZMP trajectory.

Thus, a flexible method for stabilizing mobile manipulators using dynamic arm movements during the movement of the mobile manipulator along a distinct path, which ensures that the mobile manipulator stays stable and does not tip over during the movement, may be provided. Consequently, a control strategy based on the ZMP criteria could be formulated. The desired ZMP trajectory may be based on the current motions of the mobile base and/or the current motions of the mobile arm. The desired ZMP trajectory may be required to respect the ZMP criteria and may have to lie inside the support polygon. Its exact location inside the polygon may not be restricted and may be used to optimize further criteria, for instance regarding energy optimality. Using the desired ZMP trajectory as reference trajectory, a control problem may be set up. Herein, input variables, such as the acceleration of joints of the manipulator \ddot{q}_{M} may be used. Thus, a control function ƒ may be used to minimize the deviation of the real or current ZMP trajectory from the desired ZMP trajectory. This approach may allow for dynamic arm motions to achieve that the current ZMP trajectory corresponds to the desired ZMP trajectory.

A suitable adjustment of the mobile manipulator, e.g. regarding the manipulator arm, may be determined and performed. The manipulator arm may be, for instance, adjusted in its orientation or position from a first position to a second position, such that a center of mass, and accordingly the ZMP of the mobile manipulator, may be shifted towards a more central position of the mobile manipulator, thus providing an increased stability. The mobile manipulator may be accordingly adjusted such that it might be no longer unstable when it would move along the desired movement trajectory.

The control means and controlling means may comprise respective computing means suitable to control a dynamic movement of the manipulator arm based on the respective input parameters. The manipulator arm adjustment may be performed dynamically during the movement of the mobile manipulator. The manipulator arm configuration may include a dynamic movement of the manipulator arm.

In one example of the third stabilization method, the method may further comprise the step of using “q₀, \dot{q}₀, \ddot{q}₀” as input variables for the first control function, wherein “q₀, \dot{q}₀, \ddot{q}₀” are the initial states of position, velocity and acceleration of the mobile manipulator.

The initial states may be accordingly determined by respective suitable detection or sensing means, which may be, for instance, associated with control means of the mobile manipulator. Said detection means may be the same means or different means as the detection means for determining the respective states of acceleration, velocity and position of the manipulator arm.

In one example of the third stabilization method, the method further may comprise the step of using the first control function to adjust one or more of the position, velocity and acceleration of the manipulator arm to adjust the mobile manipulator such that the real ZMP trajectory of the mobile manipulator corresponds to the desired ZMP trajectory.

Thus, any of the position, the velocity and/or the acceleration of the manipulator arm or combinations thereof may be adjusted, which may accordingly enable a flexible stability adjustment of the mobile manipulator.

In one example of the third stabilization method, the method may further comprise the step of obtaining from the first control function, the joint accelerations of the manipulator arm “\ddot{q}_{M}” as an output and executing a movement trajectory of the mobile manipulator based on that output.

However, also different outputs may be obtained, such as the state of velocity “\dot{q}_{M}” of the manipulator arm or the state of position “q_{M}” of the manipulator arm and an execution of the movement trajectory of the mobile manipulator may be based on that different output.

In one example of the third stabilization method, after executing a movement trajectory of the mobile manipulator based on that output, the method further may comprise the step of using the joint states of position and velocity “q_{M}, \dot{q}_{M}” as an input for the first control function.

Also, different inputs may be used as an input for the first control function, such as the state of acceleration “\ddot{q}_{M}” of the manipulator arm. In other words, a selected one of “\ddot{q}_{M}, \dot{q}_{M}, q_{M}”, i.e. the joint states of acceleration, velocity and position of the manipulator arm, may be obtained as an output from the first control function and the other ones of “\ddot{q}_{M}, \dot{q}_{M}, q_{M},” may be used as an input for the first control function. Thus, a dynamic re-adjustment of the executed trajectory, e.g. during movement of the mobile manipulator, may be achieved.

The second control function, which may also be referred to as planning function, may be employed, which may improve the control of the mobile manipulator further. Based on the motion of the mobile base, a reference trajectory of the ZMP may be defined over the whole path. With the joint accelerations as input variables, an optimization problem could be formulated, which may be solved in advance. Thus, a movement of the mobile manipulator may be pre-set or planned before the mobile manipulator executes a movement along the trajectory.

In one example of the third stabilization method, the method further may comprise the step of obtaining from the second control function, the desired state of the manipulator arm “(\ddot{q}_{M}, \dot{q}_{M}, q_{M})_{des}(t)” as an output.

In one example of the third stabilization method, the output of the second control function may be used as an input to adjust the mobile manipulator such that the real ZMP trajectory of the mobile manipulator corresponds to the desired ZMP trajectory, or the output of the second control function may be used as an input for the first control function.

In other words, the result or output of the second control function may be used as standalone input or as a feed forward term for the first control function to improve the mobile manipulator control strategies disclosed herein.

In a preferred embodiment, when the step of adjusting the mobile manipulator is based on the third stabilization method, the mobile manipulator comprises one or more variable mass elements, wherein the step of adjusting a center of mass of the mobile manipulator includes an adjustment of the variable mass elements, wherein the method further comprises the step of using a discrete mass parameter “mₑₓₜᵣₐ” as an input variable for the first control function and/or the second control function.

Thus, the additional mass may be considered in the planning and/or control of the manipulator, which may increase the influence on the manipulator motions. Thus, the mobile manipulator could be adjusted in addition or alternatively to the dynamic adjustment of the arm configuration by the additional masses, which may increase the flexibility, and which may extend the limits of the stabilizing adjustment.

In a preferred embodiment, the step of adjusting the mobile manipulator is based on a fourth stabilization method comprising a dynamic movement, which is controlled based on the following first control function:

$$f ( {ZMP}_{real} ( q , \dot{q} , \ddot{q} , t ) , {ZMP}_{des} ( t ) ) = mine$$

and/or, which is controlled based on the following second control function:

$$\int f ( {ZMP}_{real} ( q , \dot{q} , \ddot{q} , t ) , {ZMP}_{des} ( t ) ) ds = mine$$

wherein “ZMP_{des}(t)” is the desired ZMP trajectory; “ZMPᵣₑₐₗ” is the real ZMP trajectory; “t” is a time; “q, \dot{q}, \ddot{q}” are the joint states of position, velocity and acceleration of the mobile manipulator, and “e” is a deviation of the real ZMP trajectory from the desired ZMP trajectory; and wherein the mobile manipulator comprises a tool center point, TCP, wherein the TCP is controlled to execute a TCP-trajectory according to the following function:

$$f ( q , \dot{q} , \ddot{q} , t ) = {x}_{TCP} ( t )$$

wherein χ_{TCP}(t) is the TCP-trajectory, and wherein the TCP-trajectory is used to determine the desired ZMP trajectory “ZMP_{des}(t)”.

Thus, an additional option for properly controlling and stabilizing a mobile manipulator movement may be provided by considering the movement of the TCP. The path of the TCP may be given since the manipulator may pick or place an object. Thus, a respective first and/or second control function may be employed, using another constraint, namely the path of the TCP instead of or in addition to, for instance, the trajectories of the mobile base.

In a preferred embodiment, the step of adjusting the mobile manipulator is based on a fifth stabilization method comprising a dynamic manipulator arm movement, which is controlled based on the following first control function:

$$f ( {ZMP}_{real} ( {\ddot{q}}_{M} , {\dot{q}}_{M} , {q}_{M} , {\ddot{q}}_{BR} , {\dot{q}}_{BR} , {q}_{BR} , t ) , {ZMP}_{des} ( t ) ) = mine$$

and/or based on the following second control function:

$$\int f ( {ZMP}_{real} ( {\ddot{q}}_{M} , {\dot{q}}_{M} , {q}_{M} , {\ddot{q}}_{BR} , {\dot{q}}_{BR} , {q}_{BR} , t ) , {ZMP}_{des} ( t ) ) ds = mine$$

wherein “ZMP_{des}(t)” is the desired ZMP trajectory; “ZMPᵣₑₐₗ” is the real ZMP trajectory; “t” is a time; “\ddot{q}_{M}, \dot{q}_{M}, q_{M},” are joint states of acceleration, velocity and position of the manipulator arm; “q_{BR}, \dot{q}_{BR}, \ddot{q}_{BR}” are a rotational position, rotational velocity and rotational acceleration of the manipulator base, and “e” is a deviation of the real ZMP trajectory from the desired ZMP trajectory.

The fifth stabilization method generally corresponds to the third stabilization method with the difference that, in addition to the joint states of acceleration, velocity and position of the manipulator arm “\ddot{q}_{M}, \dot{q}_{M}, q_{M}”, a rotational position, rotational velocity and rotational acceleration “q_{B}, \dot{q}_{BR}, \ddot{q}_{BR}” of the manipulator base are considered for controlling the mobile manipulator. Thus, any of the above noted aspects concerning any of the states of acceleration, velocity and position of the manipulator arm “\ddot{q}_{M}, \dot{q}, q_{M}”, likewise apply to “q_{BR}, q_{BR}, \ddot{q}_{BR}”.

For instance, similar to the example explained above with respect to “\ddot{q}_{M}” of the third stabilization method, in one example of the fifth stabilization method, the method may comprise the step of obtaining from the first control function, the joint rotational accelerations of the manipulator base “\ddot{q}_{BR}” as an output, and may execute a movement trajectory of the mobile manipulator based on that output. Or, similar to the example explained above with respect to “q_{M}, \dot{q}_{M}” of the third stabilization method, in one example of the fifth stabilization method, after executing a movement trajectory of the mobile manipulator based on that output, the method may further comprise the step of using the joint states of rotational position and velocity “q_{BR}, \dot{q}_{BR}” of the manipulator base as an input for the first control function. This correspondence applies likewise to any one of the examples and details explained with respect to the third stabilization method.

Thus, the mobile manipulator may be adjusted in addition or alternatively to the adjustment of the arm configuration of the mobile manipulator and/or the rotation of the manipulator base, which may increase the flexibility, and which may extend the limits of the stabilizing adjustment.

Accordingly, the control means and controlling means may additionally comprise respective computing means suitable to control a rotation of the manipulator base based on the respective input parameters. The manipulator arm adjustment and the rotation of the manipulator base may be performed dynamically during the movement of the mobile manipulator. A rotation of the manipulator base may be achieved by that the mobile manipulator is an omnidirectional movable mobile manipulator that allows an omnidirectional movement of the manipulator base. Thus, the mobile manipulator may be allowed to perform a transversal movement and a rotational movement at the same time.

In a preferred embodiment, the step of adjusting the mobile manipulator is based on a sixth stabilization method comprising a dynamic manipulator arm movement, which is controlled based on the following first control function:

$$f ( {ZMP}_{real} ( q , \dot{q} , \ddot{q} , t ) , {ZMP}_{des} ( t ) ) = mine$$

and/or based on the following second control function:

$$\int f ( {ZMP}_{real} ( q , \dot{q} , \ddot{q} , t ) , {ZMP}_{des} ( t ) ) ds = mine$$

wherein “ZMP_{des}(t)” is the desired ZMP trajectory; “ZMPᵣₑₐₗ” is the real ZMP trajectory; “t” is a time; “q, \dot{q}, \ddot{q}” are the joint states of position, velocity and acceleration of the mobile manipulator, and “e” is a deviation of the real ZMP trajectory from the desired ZMP trajectory, and wherein, when the movement of the mobile manipulator is delimited by a corridor, the first control function and/or the second control function comprise an additional constraint:

$$f ( {q}_{B} , {\dot{q}}_{B} , {\ddot{q}}_{B} , t ) < corridor$$

wherein “q_{B}, \dot{q}_{B}, \ddot{q}_{B}” are the degrees of freedom of the position, the velocity and the acceleration of the manipulator base and “corridor” is a constraint value defined by the dimensions of the corridor the mobile manipulator is moving through.

Thus, the motion of the mobile manipulator may be suitably controllable if a respective corridor should be considered for the movement of the mobile manipulator. A corridor may be understood as an area on the ground, which is delimited by certain boundaries, which the mobile manipulator should not pass. Thus, the desired movement trajectory may be necessarily located within said corridor and the mobile base may be accordingly controlled to follow the desired movement trajectory within the corridor. In other words, the movement of the mobile manipulator may be restricted in that only a certain positioning, velocity and/or acceleration of the manipulator base may be allowed. The corridor may delimit the movement of the manipulator on one or more sides, e.g. at two opposing sides with a longitudinal path in between. The limitations may be achieved by respective real blocking means, such as walls. However, the corridor may also be defined virtually, such that no real blocking means are provided but that the mobile manipulator should not cross respective boundary lines or borders of the corridor. This may be useful, for instance, if a mobile manipulator works in a logistic or industrial side, wherein it should be only allowed to move along certain paths or streets. The corridor may have any desired shape e.g. in form of a longitudinal path, which may be straight or curved or have any other arbitrary shape.

In a preferred embodiment, the step of adjusting the mobile manipulator is based on a seventh stabilization method, wherein the mobile manipulator further comprises at least one external stabilizing device and wherein the step of adjusting the mobile manipulator comprises the step of supporting the mobile manipulator by the external stabilizing device.

Accordingly, a flexible method for stabilizing mobile manipulators using an external stabilization device, which ensures that the mobile manipulator may stay stable and does not tip-over, may be provided. The control of the external standardizing device may be performed by respective control means of the mobile manipulator. The control means may comprise respective computing means adapted to control a movement of the external stabilizing device based on respective input parameters such that on that the current ZMP trajectory may correspond to the desired ZMP trajectory. The manipulator arm may, for instance, be able to reach out as far as possible to have a maximum working range. Depending on the weight of the manipulator arm and/or the weight of an object arranged at a tool center point, TCP, at the distal end of the manipulator arm and its motions, the mobile manipulator may become instable and may accordingly tip over. In such a condition, the current ZMP trajectory of the mobile manipulator lies outside the support polygon. The control method of the present invention may be particularly useful for stabilizing mobile manipulators performing a stationary pick and place task.

An external stabilizing device may be an element, which may allow increasing the size of the support polygon by making contact with the environment of the mobile manipulator. The external stabilizing device may comprise multiple elements linked with each other and the mobile base to form a kinematic chain. The external stabilizing device may be in form of a telescopic arm attached to the mobile manipulator. The links of the external stabilizing device may be connected by respective joints allowing for instance a rotational motion or a linear translational displacement. However, it will be understood that the external stabilizing device may also comprise only one stiff element linked to the manipulator base. The external stabilizing device may be programmable for allowing execution of respective movements. Also more than one external stabilizing device may be provided.

The manipulator base may essentially define the core body of the mobile manipulator, at which additionally the external stabilizing device may be attached. Further additionally, the location at which the manipulator arm and/or the external stabilizing device is attached to the manipulator base may be fixed or may vary. The manipulator arm and/or the external stabilizing device may be provided at any desired side of the manipulator base, for instance at a top side, a front or back side, or at one of the lateral sides of the mobile manipulator.

When the mobile manipulator is stabilized by the external stabilizing device, the support polygon may be additionally defined by one or more contact points of the external stabilizing device, wherein the ZMP are adjusted to be located within the support polygon of the mobile manipulator.

The support polygon may be accordingly defined by an area spanned between the contact elements contacting the ground and, when the mobile manipulator is stabilized by the external stabilizing device, also by the contact point of the external stabilizing device. The contact point may be the point, at which the external stabilizing device contacts one or more supporting surfaces in the environment of the mobile manipulator, e.g., a table, a wall, or any other support element. This contact may accordingly stabilize the mobile manipulator. Accordingly, to achieve a stable condition of the mobile manipulator, the support polygon may be enlarged compared to the condition without the use of the external stabilizing device. The ZMP may be accordingly adjusted to be located in the support polygon to allow a stable movement or stand of the mobile manipulator during operation.

In one example of the seventh stabilization method, the external stabilizing device may comprise at least one telescopic support arm, which may be activated or deactivated based on the following steps: determining the ZMP of the mobile manipulator during movement of the manipulator arm, deactivating the telescopic support arm when the ZMP of the mobile manipulator is determined to be located in the support polygon, and activating the telescopic support arm when the ZMP of the mobile manipulator is determined to be located outside of the support polygon.

Thus, a flexible support method for the mobile manipulator may be provided, which may allow for a stabilization of the mobile manipulator on demand. An activation or deactivation may include an expansion or retraction of the telescopic support arm. The telescopic support arm may comprise a plurality of interconnected telescopic support arm elements, which may be moved with respect to each other in a telescopic arm like manner. The movement of the telescopic support arm elements may thus be essentially along an extension axis. The telescopic arm may be hinged at a proximal side to the manipulator base and may provide a contact with an environmental support surface at a distal side. The extension and movement of the telescopic support arm may be accordingly determined by respective sensor means and control means of the mobile manipulator, including respective motors for activating and/or deactivating the telescopic support arm.

In one example of the seventh stabilization method, the external stabilizing device may comprise at least one support wheel, wherein the support wheel, which can be activated or deactivated, wherein the support wheel, when activated, may contact the ground and may increase the support polygon of the mobile manipulator.

Thus, an additional or alternative option for stabilization may be provided. The support wheel may be similar to the propelling or driving wheels, which may move the mobile over the ground. However, the support wheel may also be configured in a completely different manner. The support wheel may be actively steered or may be passively rotatable. The support wheel may be linked to the mobile manipulator base via a support wheel axle. The support wheel axle may be formed sufficiently stable to allow a stable support of the mobile manipulator and may be formed by a single stiff element or by multiple interconnected elements, which may, for instance, operate in a telescopic arm like manner. Also more than one support wheel may be provided.

In one example of the seventh stabilization method, the control of the mobile manipulator may include the steps of: controlling the mobile manipulator in accordance with one or more stabilization methods for adjusting the mobile manipulator during the movement and controlling the telescopic support arm and/or controlling the support wheels.

Thus, a combined approach for stabilizing the mobile manipulator may be provided. The further stabilization control methods may be based on the step of adjusting the center of mass of the mobile manipulator including an adjustment of the manipulator arm configuration and/or adjusting of variable mass elements of the mobile manipulator.

One or more of the above noted stabilization control approaches may be applied, and, for instance in case the above noted approaches do not sufficiently provide a stable movement of the mobile manipulator, the telescopic support arm and/or the support wheels may be accordingly controlled to further stabilize the mobile manipulator.

In one example of the seventh stabilization method, the support wheel may be activated to extend from the manipulator base to contact the ground and to increase the support polygon of the mobile manipulator.

Thus, a flexible adjustment of the support polygon may be provided allowing for a respective control of the mobile manipulator to achieve stable movement. An activation may include an extension movement of the support wheel away from the manipulator base to increase the support surface or support polygon of the mobile manipulator. An activation may include an expansion of the support wheel axle, such that the contact of the support wheel with the ground may be suitably spaced apart from the manipulator base. Likewise, when it may be determined that no additional support is needed, the support wheel may be accordingly retracted again. The activation may include that the distance of the support wheel to the manipulator base, which is needed to stabilize the mobile manipulator, is determined and the support wheel may be accordingly controlled to extend to this distance and contact the ground.

In one example of the seventh stabilization method, the mobile manipulator may comprise a plurality of support wheels, and a selected one of the plurality of support wheels may be selected based on the following steps: applying one or more of the stabilization methods, determining if the real ZMP trajectory of the mobile manipulator corresponds to the desired ZMP trajectory considering the selected stabilization method, and, when the real ZMP trajectory of the mobile manipulator does not correspond to the desired ZMP trajectory, the method further may comprise the steps of: determining at least one support wheel suitable to increase the support polygon such that the real ZMP trajectory of the mobile manipulator corresponds to the desired ZMP trajectory, and activate the selected support wheel from the plurality of the support wheels.

Thus, a customized support of the mobile manipulator may be provided, which may use distinct support wheels from a plurality of support wheels. Accordingly, support wheels, which may not be suitable or less suitable than the selected support wheel, may be not activated. This may prevent an undue extension of the footprint of the mobile manipulator. The selection of a selected one of the support wheels may be based on spatial constraints of the environment of the mobile manipulator. Or the selection may be based on one or more optimization criteria, such as the requirement to increase the support polygon only until stable movement of the mobile manipulator is achieved. Also, more than one support wheel may be determined and activated.

In one example of the seventh stabilization method, the activation of the support wheel may include the step of determining and setting a distinct distance the support wheel extends from the manipulator base.

Hence, an unnecessary spacing of the support wheels may be prevented while a stable movement of the mobile manipulator may be achieved. The respective distance to be set may be determined and set by respective determination and control means of the mobile manipulator. This may include the determination of the extent of instability of the movable mobile manipulator based on the current and desired ZMP trajectories.

The control means may additionally comprise suitable computing and controlling means for controlling any elements of the mobile manipulator, for instance an activation or deactivation of one or more external stabilizing devices. The control means may comprise respective sensors or detectors to determine a current position or movement of the respective elements.

Any one of the above examples, aspects and details explained with respect to a certain stabilization method may be provided additionally or alternatively to any other one of the stabilization methods noted above.

Further, it is noted that the above explanations regarding certain elements or advantages described with respect to the method of controlling a mobile manipulator of the present disclosure accordingly apply to the mobile manipulator described herein. Thus, a mobile manipulator, which is particularly stable during the movement may be provided.

The invention further relates to a mobile manipulator, comprising a manipulator base, at least one manipulator arm, and a control means adapted to control the mobile manipulator in accordance with the method of the present disclosure.

Thus, a mobile manipulator may be provided, wherein the mobile manipulator may be accordingly controllable to achieve an increased stability. It is noted that the above explanations regarding certain elements or advantages described with respect to the method of controlling a mobile manipulator of the present disclosure accordingly apply to the mobile manipulator described herein. Thus, a mobile manipulator, which is particularly stable during the movement or at standstill may be provided.

In a preferred embodiment, the mobile manipulator is an autonomous mobile manipulation robot, preferably comprising more than two steerable wheels.

Thus, a flexible and reliably stabilizable autonomous mobile manipulation robot is provided. This may include any type of manipulation robot, such as a mobile manipulator which may be movable over the ground. The movement of the robot along the ground and the movement of the arm may be fully or semi-automatically controlled. At least more than two steerable wheels may allow for a particular well controlled movement over the ground. The wheels may be jointly or independently propellable or steerable. The mobile manipulation robot may be an industrial robot, a logistic robot, a medical robot, a laboratory robot or any other kind of robot, working in a respective industrial, logistic, medical or laboratory environment, that may use one or more manipulation arms arranged on a movable manipulator base to execute the desired tasks.

The invention further relates to a computer-program product comprising instructions, which, when executed by a computer, cause the computer to carry out and/or control any of the methods of the present disclosure.

The features of the system according to the present invention may be implemented by respective suitable digital or computational means, which can include, for instance, one or more computers, apps and/or networks.

The method may be at least partly computer-implemented, and may be implemented in software or in hardware, or in software and hardware. Further, the method may be carried out by computer program instructions running on means that provide data processing functions.

The data processing means may be a suitable computing means, such as an electronic control module etc., which may also be a distributed computer system. The data processing means or the computer, respectively, may comprise one or more of a processor, a memory, a data interface, or the like.

The invention further relates to a computer-readable medium comprising instructions which, when executed by a computer, cause the computer to carry out and/or control any of the methods of the present disclosure.

Any of the computer, the computer-program product and/or the computer-readable medium may be at least part of the mobile manipulator or may be arranged remotely to the mobile manipulator.

The features and advantages outlined above in the context of the system and the method similarly apply to the computer program product and the computer-readable medium described herein. Likewise, any features and advantages noted with regard to the method of to the present invention apply accordingly to the mobile manipulator of the present invention and vice versa.

A computer program may be stored/distributed on a suitable medium such as an optical storage medium or a solid-state medium, supplied together with or as part of other hardware, but may also be distributed in other forms, such as via the Internet or other wired or wireless telecommunication systems.

Further features, examples, and advantages will become apparent from the following detailed description of preferred embodiments and the accompanying figures.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### LIST OF REFERENCE SIGNS

1 mobile manipulator
3 manipulator base
5 manipulator arm
7 control means
9 contact elements
11 ground
13 mass elements
15 tool center point
17 telescopic arm
19 support wheel
50 movement of mobile base
100 computer
200 computer program product
300 computer readable medium
S1 to S21 method steps

What is claimed is:

1. A method for controlling a mobile manipulator comprising a manipulator base and at least one manipulator arm, the method comprising:
determining a current configuration of the mobile manipulator including a manipulator arm configuration and a manipulator base configuration;
determining a desired movement trajectory of the mobile manipulator;
determining a current zero-movement points (ZMP) trajectory, comprising the location of one or more current ZMP of the mobile manipulator, based on the current configuration of the mobile manipulator and the desired movement trajectory;
determining a desired ZMP trajectory of the mobile manipulator, wherein each ZMP is located within a support polygon of the manipulator base;
adjusting the mobile manipulator such that the current ZMP trajectory corresponds to the desired ZMP trajectory;
wherein the step of adjusting the mobile manipulator comprises the following steps:
selecting a stabilization method out of a group of stabilization methods and adjust the mobile manipulator based on the selected stabilization method;
determining if the real ZMP trajectory of the mobile manipulator corresponds to the desired ZMP trajectory; and
when the real ZMP trajectory of the mobile manipulator corresponds to the desired ZMP trajectory, executing a movement trajectory of the mobile manipulator.

2. The method according to claim 1, wherein, when the real ZMP trajectory of the mobile manipulator does not correspond to the desired ZMP trajectory:
selecting a different stabilization method out of the group of stabilization methods and adjusting the mobile manipulator based on the selected different stabilization method;
determining whether the real ZMP trajectory of the mobile manipulator corresponds to the desired ZMP trajectory; and
when the real ZMP trajectory of the mobile manipulator corresponds to the desired ZMP trajectory, executing a movement trajectory of the mobile manipulator; and
repeating the steps for adjusting the mobile manipulator based on one or more different stabilization methods of the group of stabilization methods until the real ZMP trajectory of the mobile manipulator corresponds to the desired ZMP trajectory.

3. The method according to claim 1, wherein the stabilization methods are hierarchically ordered, and wherein the selection of the stabilization method is performed according to the hierarchical order.

4. The method according to claim 1, wherein the step of adjusting the mobile manipulator is based on a first stabilization method comprising the step of adjusting a center of mass of the mobile manipulator including an adjustment of the manipulator arm configuration.

5. The method according to claim 1, wherein the step of adjusting the mobile manipulator is based on a second stabilization method comprising the step of adjusting a center of mass of the mobile manipulator, wherein the mobile manipulator comprises one or more variable mass elements, and wherein the step of adjusting the center of mass of the mobile manipulator includes an adjustment of the variable mass elements.

6. The method according to claim 1, wherein the step of adjusting the mobile manipulator is based on a third stabilization method comprising a dynamic manipulator arm movement, which is controlled based on the following first control function:
$$f ( {ZMP}_{real} ( {\ddot{q}}_{M} , {\dot{q}}_{M} , {q}_{M} , t ) , {ZMP}_{des} ( t ) ) = mine$$
and/or based on the following second control function:
$$\int f ( {ZMP}_{real} ( {\ddot{q}}_{M} , {\dot{q}}_{M} , {q}_{M} , t ) , {ZMP}_{des} ( t ) ) ds = mine$$
wherein “ZMP_{des}(t)” is the desired ZMP trajectory; “ZMPᵣₑₐₗ” is the real ZMP trajectory; “t” is a time; “\ddot{q}_{M}, \dot{q}_{M}, q_{M},” are joint states of acceleration, velocity and position of the manipulator arm; and “e” is a deviation of the real ZMP trajectory from the desired ZMP trajectory.

7. The method according to claim 6, wherein, when the step of adjusting the mobile manipulator is based on the third stabilization method, the mobile manipulator comprises one or more variable mass elements, and wherein the step of adjusting a center of mass of the mobile manipulator includes an adjustment of the variable mass elements, wherein the method further comprises the step of using a discrete mass parameter “mₑₓₜᵣₐ” as an input variable for the first control function and/or the second control function.

8. The method according to claim 1, wherein the step of adjusting the mobile manipulator is based on a fourth stabilization method comprising the step of adjusting the mobile manipulator comprises a dynamic movement, which is controlled based on the following first control function:
$$f ( {ZMP}_{real} ( q , \dot{q} , \ddot{q} , t ) , {ZMP}_{des} ( t ) ) = mine$$
and/or, which is controlled based on the following second control function:
$$\int f ( {ZMP}_{real} ( q , \dot{q} , \ddot{q} , t ) , {ZMP}_{des} ( t ) ) ds = mine$$
wherein “ZMP_{des}(t)” is the desired ZMP trajectory; “ZMPᵣₑₐₗ” is the real ZMP trajectory; “t” is a time; “q, \dot{q}, \ddot{q}” are the joint states of position, velocity and acceleration of the mobile manipulator (1), and “e” is a deviation of the real ZMP trajectory from the desired ZMP trajectory; and
wherein the mobile manipulator (1) comprises a tool center point (15), TCP, wherein the TCP (15) is controlled to execute a TCP-trajectory according to the following function:
$$f ( q , \dot{q} , \ddot{q} , t ) = {x}_{TCP} ( t )$$
wherein χ_{TCP}(t) is the TCP-trajectory, and wherein the TCP-trajectory is used to determine the desired ZMP trajectory “ZMP_{des}(t)”.

9. The method according to claim 1, wherein the step of adjusting the mobile manipulator is based on a fifth stabilization method comprising a dynamic manipulator arm movement, which is controlled based on the following first control function:
$$f ( {ZMP}_{real} ( {\ddot{q}}_{M} , {\dot{q}}_{M} , {q}_{M} , {\ddot{q}}_{BR} , {\dot{q}}_{BR} , {q}_{BR} , t ) , {ZMP}_{des} ( t ) ) = mine$$
and/or based on the following second control function:
$$\int f ( {ZMP}_{real} ( {\ddot{q}}_{M} , {\dot{q}}_{M} , {q}_{M} , {\ddot{q}}_{BR} , {\dot{q}}_{BR} , {q}_{BR} , t ) , {ZMP}_{des} ( t ) ) ds = mine$$
wherein “ZMP_{des}(t)” is the desired ZMP trajectory; “ZMPᵣₑₐₗ” is the real ZMP trajectory; “t” is a time; “\ddot{q}_{M}, \dot{q}_{M}, q_{M},” are joint states of acceleration, velocity and position of the manipulator arm (5); “q_{BR}, \dot{q}_{BR}, \ddot{q}_{BR}” are a rotational position, rotational velocity and rotational acceleration of the manipulator base (3), and “e” is a deviation of the real ZMP trajectory from the desired ZMP trajectory.

10. The method according to claim 1, wherein the step of adjusting the mobile manipulator (1) is based on a sixth stabilization method comprising a dynamic manipulator arm movement, which is controlled based on the following first control function:
$$f ( {ZMP}_{real} ( q , \dot{q} , \ddot{q} , t ) , {ZMP}_{des} ( t ) ) = mine$$
and/or based on the following second control function:
$$\int f ( {ZMP}_{real} ( q , \dot{q} , \ddot{q} , t ) , {ZMP}_{des} ( t ) ) ds = mine$$
wherein “ZMP_{des}(t)” is the desired ZMP trajectory; “ZMPᵣₑₐₗ” is the real ZMP trajectory; “t” is a time; “q, \dot{q}, \ddot{q}” are the joint states of position, velocity and acceleration of the mobile manipulator (1), and “e” is a deviation of the real ZMP trajectory from the desired ZMP trajectory, and
wherein, when the movement of the mobile manipulator (1) is delimited by a corridor, the first control function and/or the second control function comprise an additional constraint:
$$f ( {q}_{B} , {\dot{q}}_{B} , {\ddot{q}}_{B} , t ) < corridor$$
wherein “q_{B}, \dot{q}_{B}, \ddot{q}_{B}” are the degrees of freedom of the position, the velocity and the acceleration of the manipulator base (3) and “corridor” is a constraint value defined by the dimensions of the corridor the mobile manipulator (1) is moving through.

11. The method according to claim 1, wherein the step of adjusting the mobile manipulator is based on a seventh stabilization method, wherein the mobile manipulator further comprises at least one external stabilizing device and wherein the step of adjusting the mobile manipulator comprises the step of supporting of the mobile manipulator (1) by the external stabilizing device.

12. A mobile manipulator, comprising:
a manipulator base and at least one manipulator arm; and
a control means adapted to control the mobile manipulator according to a method method for controlling a mobile manipulator comprising a manipulator base and at least one manipulator arm, the method comprising:
determining a current configuration of the mobile manipulator including a manipulator arm configuration and a manipulator base configuration;
determining a desired movement trajectory of the mobile manipulator;
determining a current zero-movement points (ZMP) trajectory, comprising the location of one or more current ZMP of the mobile manipulator, based on the current configuration of the mobile manipulator and the desired movement trajectory;
determining a desired ZMP trajectory of the mobile manipulator, wherein each ZMP is located within a support polygon of the manipulator base;
adjusting the mobile manipulator such that the current ZMP trajectory corresponds to the desired ZMP trajectory;
wherein the step of adjusting the mobile manipulator comprises the following steps:
selecting a stabilization method out of a group of stabilization methods and adjust the mobile manipulator based on the selected stabilization method;
determining if the real ZMP trajectory of the mobile manipulator corresponds to the desired ZMP trajectory; and
when the real ZMP trajectory of the mobile manipulator corresponds to the desired ZMP trajectory, executing a movement trajectory of the mobile manipulator.

13. The mobile manipulator according to claim 12, wherein the mobile manipulator is an industrial autonomous mobile manipulation robot comprising more than two steerable wheels.

14. A computer-readable medium comprising instructions which, when executed by a computer, cause the computer to carry out a method for controlling a mobile manipulator comprising a manipulator base and at least one manipulator arm, the instructions comprising:
instructions for determining a current configuration of the mobile manipulator including a manipulator arm configuration and a manipulator base configuration;
instructions for determining a desired movement trajectory of the mobile manipulator;
instructions for determining a current zero-movement points (ZMP) trajectory, comprising the location of one or more current ZMP of the mobile manipulator, based on the current configuration of the mobile manipulator and the desired movement trajectory;
instructions for determining a desired ZMP trajectory of the mobile manipulator, wherein each ZMP is located within a support polygon of the manipulator base;
instructions for adjusting the mobile manipulator such that the current ZMP trajectory corresponds to the desired ZMP trajectory;
wherein the step of adjusting the mobile manipulator comprises:
instructions for selecting a stabilization method out of a group of stabilization methods and instructions for adjusting the mobile manipulator based on the selected stabilization method;
instructions for determining if the real ZMP trajectory of the mobile manipulator corresponds to the desired ZMP trajectory; and
when the real ZMP trajectory of the mobile manipulator corresponds to the desired ZMP trajectory, instructions for executing a movement trajectory of the mobile manipulator.
